(19) United States
(12) Patent Application Publication
(10) Pub. No.: US 2026/0313408 A1
(43) Pub. Date: Oct. 8, 2026

(54) L1-Based Measurements With Multi-Receive-Chain Reception

(71) Applicant: Apple Inc., Cupertino, CA (US)

(72) Inventors: Manasa RAGHAVAN, Sunnyvale, CA (US); Jie CUI, San Jose, CA (US); Xiang CHEN, Palo Alto, CA (US); Yang TANG, San Jose, CA (US); Konstantinos SARRIGEORGIDIS, Los Gatos, CA (US); Qiming LI, Beijing (CN)

(21) Appl. No.: 19/483,407

(22) PCT Filed: May 11, 2023
(86) PCT No.: PCT/CN2023/093614

§ 371 Date: Nov. 11, 2025

(51) Int. Cl. H04W 24/08; H04B 17/318

(52) U.S. Cl. CPC H04W 24/08; H04B 17/328

(57) ABSTRACT

A user equipment (UE) is configured to receive a first beam from a first transmission and reception point (TRP) and a second beam from a second TRP, perform physical layer (L1) measurements on both the first beam and the second beam, determine, based on the L1 measurements, whether simultaneous multi-receive-chain (multi-RX) reception is feasible and transmit a message to a base station that is indicative of whether simultaneous multi-receive-chain (multi-RX) reception is feasible.

### TECHNICAL FIELD

This application relates generally to wireless communication systems, and in particular relates to L1-based measurements with multi-receive-chain reception.

### BACKGROUND

Wireless communication systems are rapidly growing in usage. In recent years, wireless devices such as smart phones and tablet computers have become increasingly sophisticated. In addition to supporting telephone calls, many mobile devices (i.e., user equipment devices or UES) now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, is radio resource management (RRM), which includes physical layer (Layer 1, L1) measurement and reporting of various channel and communication metrics. Continued development calls for improvements and support for multi-receive-chain (multi-RX chain) reception for physical layer measurements.

### SUMMARY

Some exemplary embodiments are related to a method for wireless communications including receiving, at a user equipment (UE), a first beam from a first transmission and reception point (TRP) and a second beam from a second TRP, performing, at the UE, physical layer (L1) measurements on both the first beam and the second beam, determining, based on the L1 measurements, whether simultaneous multi-receive-chain (multi-RX) reception is feasible and transmitting a message to a base station that is indicative of whether simultaneous multi-receive-chain (multi-RX) reception is feasible.

Other exemplary embodiments are related to a method for wireless communications including receiving, at a base station, measurement data from a user equipment (UE), wherein the measurement data comprises physical layer (L1) measurements for both a first beam from a first transmission and reception point (TRP) and for a second beam from a second TRP, at the base station, determining, based on the L1 measurement from the UE, or UE signaling, whether simultaneous multi-receive-chain (multi-RX) reception is feasible and enabling simultaneous multi-RX reception functionality in response to a determination that simultaneous multi-receive-Apple chain (multi-RX) reception is feasible.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary system diagram illustrative of a device simultaneously receiving beams from two different cells, according to some embodiments.

FIG. 5 shows an exemplary diagram illustrating two TRPs with corresponding SSBs, according to some embodiments.

FIG. 6 shows an exemplary diagram illustrating two TRPs and respective associated CSI-RS resources, according to some embodiments.

FIG. 7 shows a flow diagram illustrating an exemplary method of determining whether simultaneous multi-RX reception is feasible, according to some embodiments.

FIG. 8 shows a flow diagram illustrating another exemplary method of determining whether simultaneous multi-RX reception is feasible, according to some embodiments.

### DETAILED DESCRIPTION

The exemplary embodiments may be further understood with reference to the following description and the related appended drawings, wherein like elements are provided with the same reference numerals. The exemplary embodiments relate to beam management and multi-transmission reception point (mTRP) operation, and in particular, determining whether simultaneous multi-RX reception is feasible.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The exemplary embodiments are also described with regard to a handover of the UE between a source next generation node B (gNB) and a target gNB. Those skilled in the art will understand that the term “source gNB” generally refers to a gNB that is configured to trigger the handover of the UE. In some examples, the term “source gNB” may be used to refer to a gNB that is going to trigger a handover of the UE and/or to a gNB that has already triggered a handover of the UE, but the handover procedure has not yet been completed.

Those skilled in the art will understand that term “target gNB” generally refers to a gNB that is considered as a potential future serving node for the UE. For example, the source gNB may send a handover preparation request to another gNB. The request may be accepted or denied for any of a variety of different reasons (e.g., admission control, etc.). If the request is accepted, the network may be triggered to initiate a handover of the UE from a source gNB to this gNB in response to any of a variety of different conditions. In some examples, the term “target gNB” may be used to refer to a gNB that is going to receive a handover request from a source gNB and/or to a gNB that has already received the handover preparation request from the source gNB, but the handover procedure has not been completed. Once the handover is complete, the target gNB may then be characterized as a source gNB for the UE in a subsequent handover procedure.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The exemplary embodiments are described with regard to multi-TRP (mTRP) operation and single TRP (sTRP) operation. From the perspective of the UE, mTRP operation may include establishing and maintaining a connection with multiple TRPs at the same time. For example, different channel state information (CSI)-reference signals (RS) resource sets may be configured for different TRPs to support CSI measurement. From the perspective of the UE, sTRP operation may include maintaining a connection with a single TRP.

In 5G NR, a unified transmission configuration indicator (TCI) framework is intended to facilitate streamlined mTRP operation. It has been identified that there is a need for enhancements to the unified TCI framework that improve support for mTRP operation. According to one aspect, the exemplary embodiments introduce techniques for determining whether simultaneous multi-RX reception is feasible.

While the exemplary embodiments provide benefits to the 5G NR unified TCI framework, the exemplary embodiments are not limited to the 5G NR unified TCI framework or even a 5G system. The exemplary embodiments may be applied to any appropriate type of wireless communication system. The exemplary embodiments introduced herein may be used independently from one another, in conjunction with other currently implemented mechanisms for mTRP operation, in conjunction with future implementations of mechanisms for mTRP operation or independent from other mechanisms for mTRP operation.

In addition, each gNB may support one or more cells. Throughout this description, the term “source cell” may refer to a cell operated by a source gNB. Similarly, the term “target cell” may refer to a cell operated by a target gNB. Since each qNB may support one or more cells, there may be a scenario in which multiple target cells are associated with the same target gNB. The UE may communicate with a cell over the air via a TRP. Due to the relationship between a TRP and a cell, the terms “TRP” and “cell” may be used interchangeably. For instance, in some examples, a “target cell” and a “target TRP” may be used interchangeably to generally refer to the same connection and/or node.

Further, reference may be made to a “serving cell” and a “neighbor cell.” Those skilled in the art will understand that a serving cell generally refers to a cell that is configured to transmit data to the UE. In some examples, the terms “source cell” and “serving cell” may be used interchangeably to refer to the same node. However, in some examples, the UE may be configured with multiple serving cells and each serving cell is not required to be a source cell.

Those skilled in the art will understand that a neighbor cell generally refers to a cell that is not a serving cell for the UE but located within the vicinity of the UE and/or a serving cell. In some examples, the terms “target cell” and “neighbor cell” may be used interchangeably to generally refer to the same node. However, a neighbor cell is not required to be a target cell.

The exemplary embodiments are also described with regard to L1/L2 based mobility. Those skilled in the art will understand that L1/L2 based mobility generally refers to a mechanism that allows the network to change a serving cell of the UE. For L1 based mobility, the serving cell may be changed by the network via L1 downlink control information (DCI). For L2 based mobility, the serving cell may be changed by the network via L2 medium access control (MAC) control element (CE) commands. In other examples, L1/L2 based mobility may utilize a combination of DCI, MAC CE and/or radio resource control (RRC) signaling. Thus, L1/L2 based mobility refers to two different procedures that rely on a similar concept but are distinguished from one another based on the manner in which the network triggers the UE transition from a serving cell to a target cell, e.g., DCI or MAC CE. Throughout this description, the term “L1/L2 based mobility” refers to either a L1 based mobility procedure or a L2 based mobility procedure.

The UE may perform measurements for L1/L2 based mobility on one or more neighbor cells using a specific downlink reference signal, e.g., a signal synchronization block (SSB) or a channel state information (CSI)-reference signal (RS), the measurements for L1/L2 based mobility may be based on SSB, CSI-RS or any other appropriate downlink resource. The measurement metric for L1/L2 based mobility may be L1-reference signal received power (RSRP), L1-signal interference-to-noise ratio (SINR), L1-reference signal received quality (RSRQ) or any other appropriate type of metric. However, any reference to L1/L2 based mobility utilizing a specific type of measurement, reference signal or metric is merely provided for illustrative purposes. The exemplary embodiments may apply to L1/L2 based mobility that utilizes any appropriate type of measurement, reference signal or metric.

The exemplary embodiments describe operations for receiving, at a user equipment (UE), a first beam from a first transmission and reception point (TRP) and a second beam from a second TRP. According to some of the exemplary embodiments, to be explained in detail below, the UE may perform physical layer (L1) measurements on both the first beam and the second beam. In other embodiments, to be explained in detail below, the UE may determine, based on the L1 measurements, whether simultaneous multi-receive-chain (multi-RX) reception is feasible; and if it is, the UE may transmit a message to a base station that is indicative of whether simultaneous multi-receive-chain (multi-RX) reception is feasible.

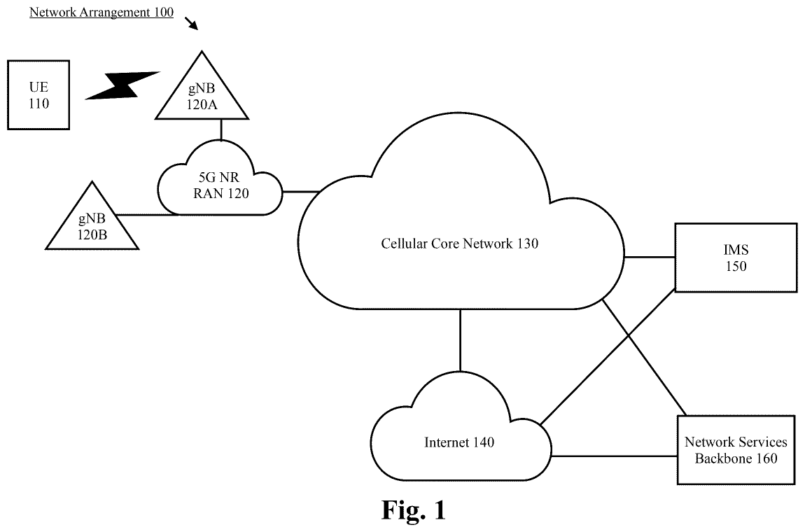

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e. g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

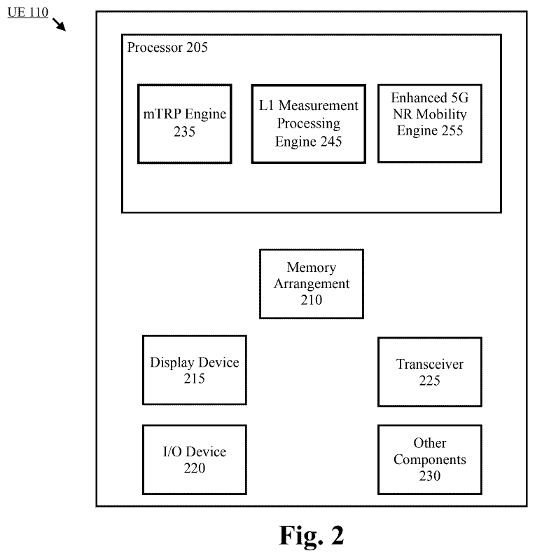

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

### The Processor 205 May Be Configured to Execute a

plurality of engines of the UE 110. For example, the engines may include a mTRP engine 235. The mTRP engine 235 may perform various operations related to mTRP operation. To provide some general examples, the mTRP engine 235 may perform operations such as, but not limited to, dynamically switching between mTRP mode and sTRP mode, updating a CC-group for mTRP operation and determining a default downlink beam/TCI-state for mTRP PDSCH reception.

The plurality of engines of the UE 110 may also include an L1 measurement reporting engine 245. The L1 measurement reporting engine 245 may perform operations including determining whether L1 measurements are colliding with L3 measurements. When such a collision is determined, some measurement results for RSs in a resource set may not be synchronized with measurement results for other RSs in the resource set. The L1 measurement reporting engine 245 may implement operations to, for example, omit certain measurement results from the measurement report or notify the network as to the whether some or all of the measurement results included in the measurement report are current or were determined in a previous measurement occasion.

The plurality of engines of the UE 110 may also include an enhanced 5G NR mobility engine 255. The enhanced 5G NR mobility engine 255 may perform various operations related to implementing the exemplary mobility framework described herein. These operations may include, but are not limited to, receiving configuration information, performing measurements, transmitting measurement reports, receiving DCI, receiving a MAC CE, etc.

The above referenced engines 235, 245, and 255 each being an application (e.g., a program) executed by the processor 205 is merely provided for illustrative purposes. The functionality associated with the engines 235, 245, and 255 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

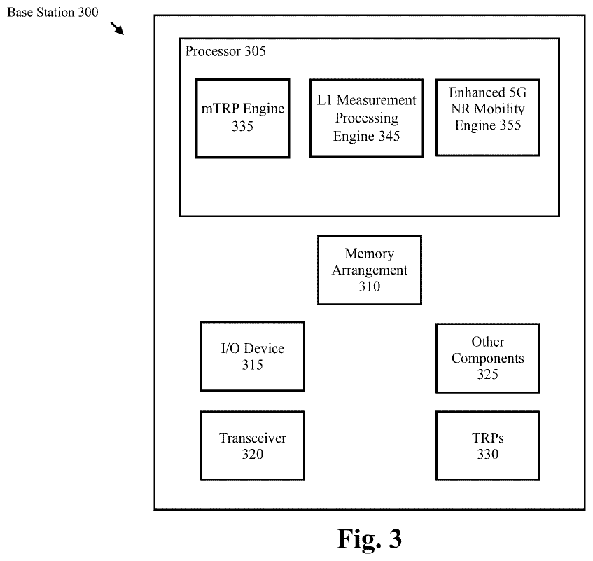

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs 330 may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP engine 335. The mTRP engine 335 may perform various operations related to mTRP operation. To provide some general examples, the mTRP engine 335 may perform operations such as, but not limited to, transmitting a signal to trigger the UE 110 to dynamically switch between mTRP mode and sTRP mode, transmitting information to update a CC-group for mTRP operation and indicating a default downlink beam/TCI-state for mTRP PDSCH reception.

The plurality of engines for the base station 300 may also include an L1 measurement processing engine 345. The L1 measurement processing engine 345 may perform operations including receiving and processing measurement reports from a UE and performing beam management in reliance thereon.

The plurality of engines may include an enhanced 5G NR mobility engine 355. The enhanced 5G NR mobility engine 355 may perform various operations related to the exemplary mobility framework described herein. These operations may include, but are not limited to, transmitting a handover preparation request to another gNB, receiving capability information, transmitting configuration information, receiving measurement data, assigning resources, transmitting reference signals, transmitting DCI, transmitting a MAC CE, etc.

The above noted engines 335, 345, and 355 each being an application (e.g., a program) executed by the processor 305 is only exemplary. The functionality associated with the engines 335, 345, and 355 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

As mentioned above, the exemplary embodiments relate to a unified TCI framework that is configured to facilitate mTRP operation. Those skilled in the art will understand that a TCI state may indicate that a beam is quasi co-located to specific reference signal and define a search space. Thus, the TCI state may indicate the location of one or more search spaces relative to one or more reference signals. During operation, the UE 110 may be configured with multiple TCI states and the network may indicate which of the TCI states are to be used for subsequent communication.

In 5G NR, a unified TCI state may be used for multiple channels simultaneously. The network may configure a common TCI pool and then indicate one or more TCI states from the common TCI pool to be used for subsequent communication. For example, a unified TCI state may be commonly applied to downlink signals, e.g., reference signals, a control resource set (CORSET), physical downlink shared channel (PDSCH), etc. In another example, a unified TCI state may be commonly applied to uplink signals, e.g., physical uplink shared channel (PUSCH), physical uplink control channel (PUCCH), sounding reference signals (SRS), etc. In another example, a unified TCI state may be commonly applied for multiple uplink and downlink channels. In this example, there may be a joint TCI state pool for the uplink/downlink or there may be a separate downlink TCI state pool and uplink TCI state pool. The exemplary embodiments may be applied to both the joint TCI state pool mechanisms and the separate TCI state pool mechanism.

### Measurement and Reporting During Wireless Communications

As previously mentioned, wireless communications, such as NR cellular wireless communications, involve measurement and reporting of various channel and communication metrics. The evolution of 5G New Radio (NR) requires support for group-based beam reporting to report on multiple received beams, for example on a simultaneously received pair of beams.

In Release 18 (R18) of the 3GPP standard, a requirement for NR frequency range 2 (FR2) multi-RX chain downlink (DL) reception was formulated with certain objectives. One objective is to specify radio frequency (RF) requirements, mainly spherical coverage requirements, for devices with simultaneous reception from different directions with different quasi-co-located (QCL) TypeD reference signals (RSS). According to these requirements, the legacy spherical coverage requirements for reception from a single direction are retained. Additionally, power class 3 (PC3) is prioritized, with other power classes considered, once the PC3 requirements framework has been finalized.

Pursuant to the above, the following RRM requirements may receive consideration:
L1-RSRP measurement delay,
Layer 3 (L3) measurement delay (both cell detection delay and measurement period can be considered). The starting point is the enhancements related to L1-RSRP measurement enhancements,
Radio link monitoring (RLM) and beam failure detection/candidate beam detection (BFD/CBD) requirements,
Scheduling/measurement restrictions,
Transmission Configuration Indication (TCI) state switching delay with dual TCI, and
Receive timing difference between different directions (different QCL Type D RSs).

### Group-Based Beam Reporting on a Pair of Beams Received Simultaneously

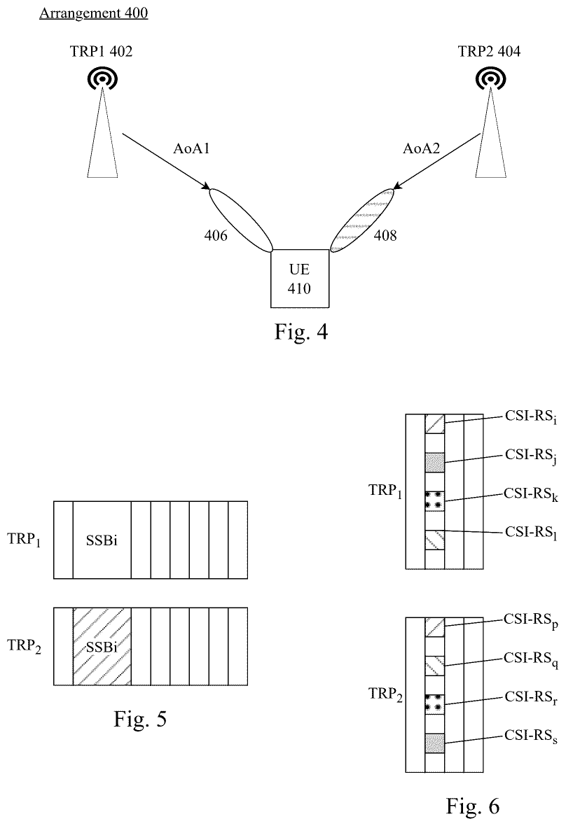

As disclosed herein, for multi-RX support, a UE may support group-based beam reporting to report on multiple received beams, for example on a pair of beams received simultaneously. FIG. 4 shows an exemplary system diagram illustrative of a UE 410 simultaneously receiving a beam 406 from a first cell 402 and a beam 408 from a second cell 404. As shown in FIG. 4, the respective angle of arrival (AoA) for each beam is different at UE 410.

The following functionality (e.g., by way of communication parameters) may thereby be implemented:
groupBeamReporting to report L1-RSRP on one (1) pair of received beams ;
groupSINR-reporting-r16 to report L1-SINR on one (1) pair of received beams; and
mTRP-GroupBasedL1-RSRP-r17 to report L1-RSRP on up to four (4) pairs of received beams.

Currently, requirements are only defined for single panel reception for L1-RSRP and L1-SINR measurements. As disclosed herein, L1 measurements are enhanced to support group-based reporting for at least the following:
SSB based (simultaneous) L1-RSRP measurements,
CSI-RS based (simultaneous) L1-RSRP measurements,
SSB based (simultaneous) L1-SINR measurements, and
CSI-RS based (simultaneous) L1-SINR measurements.

### SSB Based Measurement—L1-RSRP

SSB Based L1-RSRP measurement(s) for single RX are currently defined for a serving cell, and for a cell with a different PCI than the serving cell (for inter-cell beam management). For multi-RX reception, for example with simultaneous beam reception, requirements may be defined for:
1. simultaneous reception from a serving cell and a cell with a different PCI (than the serving cell) ; and
2. simultaneous reception and L1-RSRP of two (2) SSBs from a serving cell and a cell with different PCI (than the serving cell).

Regarding (1) above, SSBs from the same cell with the same index may not be transmitted from different transmission and reception points (TRPs), and each SSB index may be associated with a TX beam. Regarding (2) above, there are currently sharing factors/resource sharing between the serving cell and a cell with a different PCI (than the serving cell), for overlapping SSBs. With simultaneous reception, the UE may measure both simultaneously, with no sharing factor or resource sharing required. That is, any L1-RSRP measurements or beam failure detection/candidate beam detection (BFD/CBD) measurements are performed with no sharing factor and/or no resource sharing.

FIG. 5 shows an exemplary diagram illustrating two TRPs with corresponding SSBs. The UE may simultaneously receive the respective SSBs from TRP1 and TRP2 and measure both simultaneously to obtain the L1-RSRP measurements.

### CSI-RS Based Measurement—L1 RSRP

Support may also be provided for CSI-RS based measurements with multi-RX chains. In some embodiments, two sets of resources may be configured for each TRP/AoA (Angle of Arrival). For example, a number (N) of resources may be defined per set, and/or the UE may take measurements for a pair of resources simultaneously. As an example, for the measurement of one resource (single TRP), the UE may acquire 8*T_{CSI-RS} Samples for beam refinement. Accordingly, for measurement on one pair of non-overlapping resources, with simultaneous measurement, the UE may acquire 8*T_{CSI-RS} samples for beam refinement.

FIG. 6 shows an exemplary diagram illustrating two TRPs, TRP1 and TRP2, and respective associated four pairs of overlapping CSI-RS resources (CSI-RSᵢ to CSI-RSⱼ and CSI-RSₚ to CSI-RSₛ, respectively). For two overlapping resources per set, the UE may measure on four pairs of resources, and if all resources are overlapping, the UE may acquire 4*8* T_{CSI-RS} samples for beam refinement/measurement. In general, for N overlapping resources on two sets, the UE may measure N² pairs of resources, acquiring N*N*8*T_{CSI-RS} samples for beam refinement/measurement.

### CSI-RS Based Measurement—L1 SINR

CSI-RS based L1-SINR measurements may be defined for at least two configurations, (1) CSI-RS based channel measurement resource (CMR) with no dedicated interference measurement resource (IMR) and (2) CSI-RS based CMR with dedicated IMR. For (1), both signal and interference may be measured on the same resource. For (2), the signal and interference may be measured on different resources.

In some embodiments, group-based L1-SINR reporting may be supported for one pair of resources. The current requirements may be applicable, with the UE supporting multi-RX chain measurements on a pair of resources, for example supporting simultaneous measurements over multi-RX chains. Accordingly, the UE may acquire 8*T_{CSI-RS} samples for beam refinement for measurement on one pair of resources.

Group-based beam reporting may be extended to up to ‘N’ resources for multi-RX chain/multi-TRP measurements. For measurements on one pair of non-overlapping resources, e.g., when simulations measurements are performed, the UE may acquire 8*T_{CSI-RS} samples for beam refinement. For two overlapping resources per set, the UE may measure on four pairs of resources. If all resources are overlapping, 4*8*T_{CSI-RS} samples may be acquired for beam refinement/measurement. For N overlapping resources on two sets, the UE may measure N² pairs of resources, acquiring N*N*8*T_{CSI-RS} samples for beam refinement/measurement.

### Simultaneous Multi-RX Reception

Simultaneous multi-Rx reception is possible only in certain conditions. Likewise, reduction to L1 measurement delays for inter-cell beam management with multi-RX reception is only possible in certain conditions. The network may not be aware of whether simultaneous multi-Rx reception is possible or feasible for the UEs. Thus, it may be beneficial for an UE to indicate to the network when simultaneous reception and L1 measurement delay reduction is possible.

For example, simultaneous reception with two panel/separate receive chains is possible when there is sufficient separation between the two AoAs from different TRPs. Further, simultaneous reception with two panels is possible when the UE panel placement allows efficient isolation between signals from different TRPs. The L1 measurement delay reduction or sharing factor reduction is possible when the above side conditions are met. Otherwise, the sharing factor is applicable.

However, the network may not be aware of the amount or degree of the AoA separation at any particular UE. The orientation and rotation of the UE might change the conditions for simultaneous reception. In this disclosure, the UE may indicate to the network if simultaneous reception and/or sharing factor reduction is possible. In one example, this may be done through measurements at the UE side for L1-RSRP/L1-SINR. Through these measurements, the UE can determine if simultaneous reception with multi-RX chains is feasible. The UE then indicates to the network via RRC or MAC CE signaling that measurement delay reduction is applicable or not applicable. In addition, if group-based beam reporting is enabled for a serving cell and a cell with different PCI, the network can determine if measurement delay reduction is applicable or not applicable, based on a group-based report or an absence of a group-based report.

### Exemplary Method for Performing Physical Layer Measurements

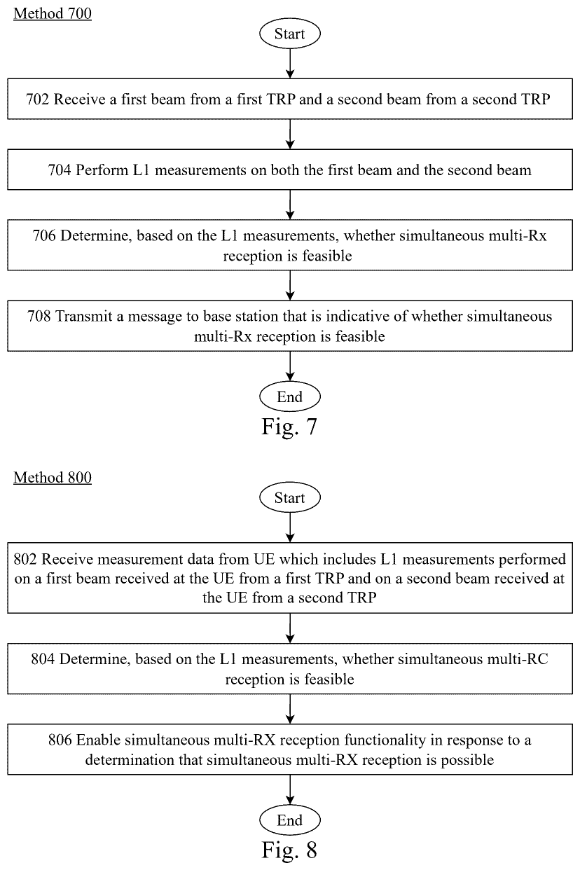

FIG. 7 shows an exemplary flow diagram illustrating a method (700) for performing physical layer (L1) measurements and using the L1 measurements to determine whether simultaneous multi-RX reception is feasible. The L1 measurements may be on respective beams received from multiple TRPS. In some embodiments, the measurements may be on respective beans received simultaneously from multiple TRPs. A device, for example a mobile device (UE), such as UE 110 or UE 410 disclosed herein, may receive a first beam from a first TRP and a second beam from a second TRP (702). The device may then perform L1 measurements on both beams (704). In one embodiment, the L1 measurements may be performed simultaneously on both beams. The L1 measurements may include SSB based L1-RSRP measurements, CSI-RS based L1-RSRP measurements, SSB based (simultaneous) L1-SINR measurements, and/or CSI-RS based L1-SINR measurements.

In 704, the UE 110 may configure the UE 110 to perform measurement collection and/or reporting. In one example, the source gNB, such as gNB 120A disclosed herein, may provide the UE 110 information about the beam resources of multiple TRPs. This information may enable the UE 110 to collect measurement data corresponding to multiple different TRPs. In one embodiment, the UE 110 may request the beam resource information from the base station (gNB 120A) prior to performing the L1 measurements.

Based on these L1 measurements, the UE 110 may determine whether simultaneous multi-RX reception is feasible (706). The UE may then send a message to the network (i.e., to a base station or gNB, such as gNB 120A) indicating whether simultaneous multi-RX is feasible (708). In 708, the UE 110 may provide a measurement report with the collected L1 measurement data. To provide a general example, the UE 110 may be configured with a measurement gap (or configured to perform gap-less measurements) to collect measurement data on the multiple TRPs. The UE 110 may monitor and/or analyze the measurement data for the multiple TRPs and if a predetermined condition occurs (e.g., measurement data exceeds threshold value, etc.), the UE 110 may be triggered to provide a message or indication to the network that simultaneous multi-RX reception is feasible. In one embodiment, this indication may be sent as part of a measurement report. The network may utilize the indication to determine whether to enable simultaneous multi-RX reception functionality.

For example, if simultaneous multi-RX reception is feasible, the UE 110 can transmit a message to the base station or gNB 120A indicating that simultaneous multi-RX reception is feasible. If simultaneous multi-RX reception is not feasible, the UE 110 can transmit a message to the base station or gNB 120A indicating that simultaneous multi-RX reception is not feasible, or in the alternative, may not transmit any message to the network (i.e., base station or gNB). If the base station or qNB 120A receives a message indicating that simultaneous multi-RX reception is feasible, the base station can then enable simultaneous multi-RX reception functionality if desired.

FIG. 8 shows a flow diagram illustrating another exemplary method (800) for performing physical layer (L1) measurements and using the L1 measurements to determine Whether simultaneous multi-RX reception is feasible. The L1 measurements may be on respective beams received from multiple TRPs. In the embodiment of FIG. 8, it may be the base station or gNB, such as gNB 120A, that makes the determination that simultaneous multi-RX reception is feasible. A device, for example a base station or gNB 120A, may receive (802) measurement data from a mobile device (UE), such as UE 110. In one embodiment, the measurement data may be received from the UE 110 in response to a request from the base station, although this is optional. In this case, the base station or gNB 120A may provide the UE 110 about the beam resources of multiple TRPs, which may enable the UE 110 to collect measurement data corresponding to multiple different TRPs. The measurement data may be received as part of a measurement report from the UE 110. The measurement data may include measurements representative of L1 measurements performed at the UE 110 on a first beam received at the UE from a first TRP and a second beam received at the UE from a second TRP. In one embodiment, the L1 measurements may be performed simultaneously on both beams. The L1 measurements may include SSB based L1-RSRP measurements, CSI-RS based L1-RSRP measurements, SSB based (simultaneous) L1-SINR measurements, and/or CSI-RS based L1-SINR measurements.

Based on these L1 measurements, the base station 120A may determine whether simultaneous multi-RX reception is feasible (804). The base station 120A may analyze the measurement data for multiple TRPs and if a predetermined condition occurs (e.g., measurement data exceeds a threshold value, etc.), the base station 120A may be triggered to determine that simultaneous multi-RX reception is feasible. The network may then decide whether to enable simultaneous multi-RX reception functionality. In one example (806), the base station 120A may automatically enable the multi-RX reception functionality if the predetermined condition occurs (e.g., measurement data exceeds a threshold value). In other examples, the base station 120A may use additional information or factors to determine whether to enable simultaneous multi-RX reception functionality when the predetermined condition occurs.

### EXAMPLES

In a first example, a method for wireless communications, the method comprising receiving, at a user equipment (UE), a first beam from a first transmission and reception point (TRP) and a second beam from a second TRP, performing, at the UE, physical layer (L1) measurements on both the first beam and the second beam, determining, based on the L1 measurements, whether simultaneous multi-receive-chain (multi-RX) reception is feasible and transmitting a message to a base station that is indicative of whether simultaneous multi-receive-chain (multi-RX) reception is feasible.

In a second example, the method of the first example, wherein the L1 measurements comprise one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam, (c) L1 signal-to-interference-plus-noise ratio (L1-SINR) measurements based on respective SSBs associated with the first beam and the second beam or (d) L1-SINR measurements based on respective channel state information reference signals (CSI-RSs) associated with the first beam and the second beam.

In a third example, the method of the second example, wherein for (a), the first TRP is a serving cell and the second TRP is a cell with a different physical cell identifier (PCI) than the serving cell.

In a fourth example, the method of the second example, wherein for (a), the first TRP and the second TRP are from a serving cell.

In a fifth example, the method of the second example, wherein any L1-RSRP measurements or beam failure detection/candidate beam detection (BFD/CBD) measurements are performed with no sharing factor and/or no resource sharing.

In a sixth example, the method of the first example, wherein the message transmitted to the base station is transmitted via medium access control (MAC) control element (CE) commands and/or through radio resource control (RRC) signaling.

In a seventh example, the method of the first example, wherein the first beam and the second beam are received simultaneously by the UE and the L1 measurements are simultaneous L1 measurements.

In an eighth example, the method of the first example, further comprising receiving, from the base station, information related to beam resources of the first TRP and the second TRP, the information related to the beam resources to be used in the performing of the L1 measurements.

In a ninth example, the method of the first example, wherein the determining whether simultaneous multi-RX reception is feasible comprises determining, based on the L1 measurements, if a predetermined condition occurs.

In a tenth example, the method of the ninth example, wherein the predetermined condition is that at least one of the L1 measurements exceeds a threshold value.

In an eleventh example, the method of the ninth example, wherein the transmitting of the message to the base station occurs automatically if the predetermined condition is determined to have occurred.

In a twelfth example, the method of the first example, wherein the transmitting the message to the base station comprises transmitting an indication that multi-RX reception is feasible.

In a thirteenth example, the method of the first example, wherein the transmitting the message to the base station comprises transmitting an indication that multi-RX reception is not feasible.

In a fourteenth example, the method of the first example, wherein the transmitting the message to the base station comprises transmitting a group-based beam report including the L1 measurements.

In a fifteenth example, a processor of a user equipment (UE) configured to perform any of the methods of the first through fourteenth examples.

In a sixteenth example, a user equipment (UE) comprising a transceiver configured to communicate with a network and a processor communicatively coupled to the transceiver and configured to perform any of the methods of the first through fourteenth examples.

In a seventeenth example, a method for wireless communications, the method comprising receiving, at a base station, measurement data from a user equipment (UE), wherein the measurement data comprises physical layer (L1) measurements for both a first beam from a first transmission and reception point (TRP) and for a second beam from a second TRP, at the base station, determining, based on the L1 measurement from the UE, or UE signaling, whether simultaneous multi-receive-chain (multi-RX) reception is feasible and enabling simultaneous multi-RX reception functionality in response to a determination that simultaneous multi-receive-chain (multi-RX) reception is feasible.

In an eighteenth example, the method of the seventeenth example, wherein the L1 measurements comprise one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam, (c) L1 signal-to-interference-plus-noise ratio (L1-SINR) measurements based on respective SSBs associated with the first beam and the second beam or (d) L1 signal-to-interference-plus-noise ratio (L1-SINR) measurements based on respective channel state information reference signals (CSI-RSs) associated with the first beam and the second beam.

In a nineteenth example, the method of the eighteenth example, wherein for (a), the first TRP is a serving cell and the second TRP is a cell with a different physical cell identifier (PCI) than the serving cell.

In a twentieth example, the method of the eighteenth example, wherein for (a), the first TRP and the second TRP are from a serving cell.

In a twenty first example, the method of the eighteenth example, wherein any L1-RSRP measurements or beam failure detection/candidate beam detection (BFD/CBD) measurements are performed with no sharing factor and/or no resource sharing.

In a twenty second example, the method of the seventeenth example, wherein the UE signaling is received from the UE via medium access control (MAC) control element (CE) commands and/or through radio resource control (RRC) signaling.

In a twenty third example, the method of the seventeenth example, wherein the L1 measurements are simultaneous physical layer (L1) measurements and the first beam and the second beam were received simultaneously by the UE.

In a twenty fourth example, the method of the seventeenth example, wherein the measurement data is received from the UE in response to a request for measurement data at the UE from the base station.

In a twenty fifth example, the method of the twenty fourth example, further comprising transmitting information related to beam resources of the first TRP and the second TRP from the base station to the UE prior to, or in conjunction with, the request for measurement data, the information related to the beam resources to be used by the UE in performing of the L1 measurements.

In a twenty sixth example, the method of the seventeenth example, wherein the determining whether simultaneous multi-RX reception is feasible comprises determining, based on the L1 measurements, if a predetermined condition occurs.

In a twenty seventh example, the method of the twenty sixth example, wherein the predetermined condition is that at least one of the L1 measurements exceeds a threshold value.

In a Twenty Eighth Example, the Method of the Twenty sixth example, wherein the enabling of the simultaneous multi-RX reception functionality occurs automatically if the predetermined condition is determined to have occurred.

In a twenty ninth example, the method of the twenty sixth example, wherein the enabling of the simultaneous multi-RX reception functionality occurs based on additional information in addition to whether the predetermined condition is determined to have occurred.

In a thirtieth example, the method of the seventeenth example, wherein the measurement data is included in a group-based beam report received at the base station from the UE.

In a thirty first example, a processor of a base station configured to perform any of the methods of the seventeenth through thirtieth examples.

In a thirty second example, a base station comprising a transceiver configured to communicate with a user equipment (UE) and a processor communicatively coupled to the transceiver and configured to perform any of the methods of the seventeenth through thirtieth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICS. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method for wireless communications, the method comprising:
receiving, at a user equipment (UE), a first beam from a first transmission and reception point (TRP) and a second beam from a second TRP;
performing, at the UE, physical layer (L1) measurements on both the first beam and the second beam;
determining, based on the L1 measurements, whether simultaneous multi-receive-chain (multi-RX) reception is feasible; and
transmitting a message to a base station that is indicative of whether simultaneous multi-receive-chain (multi-RX) reception is feasible.

2. The method of claim 1, wherein the L1 measurements comprise one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam;
(c) L1 signal-to-interference-plus-noise ratio (L1-SINR) measurements based on respective SSBs associated with the first beam and the second beam; or
(d) L1-SINR measurements based on respective channel state information reference signals (CSI-RSs) associated with the first beam and the second beam.

3. The method of claim 2, wherein for (a), the first TRP is a serving cell and the second TRP is a cell with a different physical cell identifier (PCI) than the serving cell.

4. The method of claim 2, wherein for (a), the first TRP and the second TRP are from a serving cell.

5. The method of claim 2, wherein any L1-RSRP measurements or beam failure detection/candidate beam detection (BFD/CBD) measurements are performed with no sharing factor and/or no resource sharing.

6. The method of claim 1, wherein the message transmitted to the base station is transmitted via medium access control (MAC) control element (CE) commands and/or through radio resource control (RRC) signaling.

7. The method of claim 1, wherein the first beam and the second beam are received simultaneously by the UE and the L1 measurements are simultaneous L1 measurements.

8. The method of claim 1, further comprising receiving, from the base station, information related to beam resources of the first TRP and the second TRP, the information related to the beam resources to be used in the performing of the L1 measurements.

9. The method of claim 1, wherein the determining whether simultaneous multi-RX reception is feasible comprises determining, based on the L1 measurements, if a predetermined condition occurs.

10. The method of claim 9, wherein the predetermined condition is that at least one of the L1 measurements exceeds a threshold value.

11. The method of claim 9, wherein the transmitting of the message to the base station occurs automatically if the predetermined condition is determined to have occurred.

12. The method of claim 1, wherein the transmitting the message to the base station comprises transmitting an indication that multi-RX reception is feasible.

13. The method of claim 1, wherein the transmitting the message to the base station comprises transmitting an indication that multi-RX reception is not feasible.

14. The method of claim 1, wherein the transmitting the message to the base station comprises transmitting a group-based beam report including the L1 measurements.

15. A method for wireless communications, the method comprising:
receiving, at a base station, measurement data from a user equipment (UE), wherein the measurement data comprises physical layer (L1) measurements for both a first beam from a first transmission and reception point (TRP) and for a second beam from a second TRP;
at the base station, determining, based on the L1 measurement from the UE, or UE signaling, whether simultaneous multi-receive-chain (multi-RX) reception is feasible; and
enabling simultaneous multi-RX reception functionality in response to a determination that simultaneous multi-receive-chain (multi-RX) reception is feasible.

16. The method of claim 15, wherein the L1 measurements comprise one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam;
(c) L1 signal-to-interference-plus-noise ratio (L1-SINR) measurements based on respective SSBs associated with the first beam and the second beam; or
(d) L1 signal-to-interference-plus-noise ratio (L1-SINR) measurements based on respective channel state information reference signals (CSI-RSs) associated with the first beam and the second beam.

17. The method of claim 15, wherein the determining whether simultaneous multi-RX reception is feasible comprises determining, based on the L1 measurements, if a predetermined condition occurs.

18. The method of claim 17, wherein the predetermined condition is that at least one of the L1 measurements exceeds a threshold value.

19. The method of claim 17, wherein the enabling of the simultaneous multi-RX reception functionality occurs automatically if the predetermined condition is determined to have occurred.

20. The method of claim 17, wherein the enabling of the simultaneous multi-RX reception functionality occurs based on additional information in addition to whether the predetermined condition is determined to have occurred.
